(19) United States
(12) Patent Application Publication
(10) Pub. No.: US 2023/0341672 A1
(43) Pub. Date: Oct. 26, 2023

(54) FOCAL PLANE SPACERS FOR MICROSCOPE SLIDES AND RELATED SYSTEMS AND METHODS

(71) Applicant: LEAVITT MEDICAL, INC. D/B/A LUMEA, Lehi, UT (US)

(72) Inventors: Mark S. Evans, Holliday, UT (US); Michael Andrew Ivie, Orem, UT (US)

(21) Appl. No.: 17/920,349

(22) PCT Filed: Apr. 21, 2021
(86) PCT No.: PCT/US2021/028472

§ 371 Date: Oct. 20, 2022

Related U.S. Application Data
(60) Provisional application No. 63/014,958, filed on Apr. 24, 2020.

(51) Int. Cl. G02B 21/34; G01B 9/04

(52) U.S. Cl. CPC G02B 21/34; G01B 9/04

(57) ABSTRACT

The disclosed spacers for microscope slides may include a spacer body including a material configured to provide an optical focal reference for a microscope and a central opening in the spacer body sized and shaped to receive a cytological sample. The spacer body may have a thickness of about 20 μm or less. Methods of analyzing cytological samples may include disposing a cytological sample on a microscope slide adjacent to a spacer positioned on the microscope slide, focusing an optical module of a microscope to a focal plane using at least a portion of the spacer as a focal reference, and viewing the cytological sample through the optical module of the microscope at the focal plane. Various other related methods, systems, and devices are also disclosed.

### PRIORITY CLAIM

This application claims priority to U.S. Provisional Application No. 63/014,958, titled “FOCAL PLANE SPACERS FOR MICROSCOPE SLIDES AND RELATED SYSTEMS AND METHODS, filed 24 Apr. 2020, the entire disclosure of which is hereby incorporated by reference herein.

### BACKGROUND

Cytopathology is screening and/or diagnosing diseases by looking at single cells and small clusters of cells. The cells for cytopathology can be obtained in a variety of ways. For example, fine needle aspiration (FNA) may be performed to obtain cells from virtually any organ. Body fluids may also be collected, such as urine, sputum, cerebrospinal fluid (CSF), pleural fluid, pericardial fluid, or ascitic (peritoneal) fluid. Conventional cell collection techniques also include scraping or brushing cells from an organ or tissue, such as from a uterine cervix (e.g., for a Pap test), an esophagus, a stomach, bronchi, a mouth, etc. The collected cells are often placed in a liquid to form a cytological solution. Cytological samples may also be collected and analyzed for other reasons, such as for scientific research and education.

Compared with typical tissue biopsies, cytology specimens are sometimes cheaper, easier to harvest with less discomfort to the patient, and are less likely to result in serious complications. However, there are typically lower concentrations of cells in a collected cytological sample compared to a typical bulk tissue biopsy. It is often difficult to find, focus on, and view cells of a cytological sample through a microscope, especially if the cell concentrations are low and cells are widely dispersed within the cytological sample. Thus, properly viewing potentially disperse cells in a cytological samples, such as with a microscope, can be challenging.

### SUMMARY

In some embodiments, the present disclosure includes spacers for microscope slides. The spacers may include a spacer body and a central opening in the spacer body. The spacer body may include a material configured to provide an optical focal reference for a microscope. The spacer body may have a thickness of about 20 μm or less. The central opening may be sized and shaped to receive a cytological sample.

In some examples, the spacer body may have a substantially circular outer perimeter or a substantially rectangular outer perimeter. By way of example, the central opening may have a substantially circular shape or a substantially rectangular shape. The material of the spacer body may include a translucent material. The spacer body may include at least one discrete focal feature, which may include at least one of: a pigment; a biological cell; a protein material; and/or a lipid material.

In some embodiments, the present disclosure includes methods of analyzing a cytological sample. In accordance with such methods, a cytological sample may be disposed on a microscope slide adjacent to a spacer positioned on the microscope slide. An optical module of a microscope may be focused to a focal plane using at least a portion of the spacer as a focal reference. The cytological sample may be viewed through the optical module of the microscope at the focal plane.

In some examples, the method may also include positioning the spacer on the microscope slide, such as by positioning a spacer having a thickness of about 20 μm or less. The spacer may be positioned on the microscope slide by at least one of: inkjet printing a material of the spacer on the microscope slide; applying the material of the spacer to the microscope slide through a stencil; disposing the material of the spacer on the microscope slide via a chemical vapor deposition process; or positioning a preformed spacer on the microscope slide. The method may further include capturing an image of the cytological sample with an image capture device through the optical module of the microscope. For example, the image capture device may include a digital image sensor. Viewing the cytological sample through the optical module of the microscope at the focal plane may include viewing the cytological sample with the image capture device.

In some embodiments, the present disclosure includes microscope slide systems. Such systems may include a microscope slide base and a spacer positioned on the microscope slide base. The spacer may include at least one optical focal reference feature for a microscope. The spacer may have a thickness of about 20 μm or less.

In some examples, the systems may also include a cover slip configured to be positioned over the spacer. The spacer may include a central opening sized for receiving a cytological sample. The at least one optical focal reference feature may include at least one of: a pigment; or a biological material. The spacer may include distinct and separated spacer portions positioned on the microscope slide base.

### BRIEF DESCRIPTION OF THE DRAWINGS

FIG. 1 is a perspective top view of a microscope slide system including a spacer, according to at least one embodiment of the present disclosure.

FIGS. 2-5 are perspective views of spacers having various configurations, according to several embodiments of the present disclosure.

FIG. 6 is a side view of a microscope in use with a microscope slide system according to at least one embodiment of the present disclosure.

FIG. 7 is a flow diagram illustrating a method of analyzing a cytological sample, according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION

The present disclosure generally relates to spacers, systems, and methods that may facilitate viewing cytological samples through a microscope. In some embodiments, the disclosed systems and methods employ a spacer that includes at least one optical focal reference that can be used to set a microscope to a focal plane that is in a same plane as cells in the cytological sample. The concepts disclosed herein may enable improved analysis of cytological samples, as will be apparent to those skilled in the art upon reviewing the present disclosure.

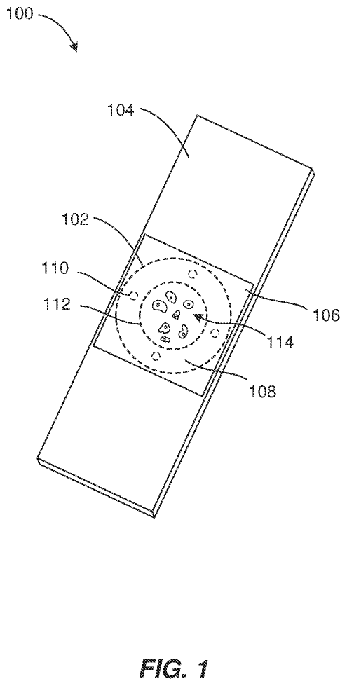

FIG. 1 is a perspective top view of a microscope slide system 100 including a spacer 102 on a microscope slide base 104. A cover slip 106 may be sized and configured to be disposed over the spacer 102. The spacer 102 may include a spacer body 108 that includes a material configured to provide an optical focal reference for a microscope. For example, the spacer body 108 may include a transparent or translucent material and at least one optical focal feature 110 in or on the spacer body 108.

By way of example and not limitation, the material of the spacer body 108 may include a polymer material, a gelatin material, or a tissue mimetic material. For example, a tissue mimetic material may include biological and/or synthetic material that mimic a biological sample. In some embodiments, the tissue mimetic material may include at least one biological cell, a protein material, and/or a lipid material. Tissue mimetic materials that are suitable for use in the spacer body 108 of this disclosure are disclosed in U.S. Pat. No. 9,851,349, titled “MATRIX FOR RECEIVING A TISSUE SAMPLE AND USE THEREOF,” issued Dec. 26, 2017, the entire disclosure of which is incorporated by reference herein. An example material that may be used in the spacer body 108 may include at least one of: protein (e.g., animal protein), one or more lipids (e.g., animal fat, vegetable oil, etc.), glycerin, water, a gelling agent (e.g., an ionically gelled gelling agent), an inorganic buffer, an antifoaming agent, and/or a paraffin wax material. The optical focal feature 110 may include a biological cell, a protein material, or a lipid material of the tissue mimetic material.

In additional embodiments, the spacer 102 may include a translucent or transparent material (e.g., a polymer, glass, or gelatin material) with the optical focal feature 110 within and/or on the translucent or transparent material. For example, the optical focal feature 110 may be or include a pigment, such as a printed dot, line, circle, etc. In additional examples, the pigment may include grains or other discrete masses of pigment distributed in the material of the spacer body 108. In some embodiments, the optical focal feature 110 may be a discrete focal feature. In additional embodiments, a plurality of optical focal features 110 may be dispersed in the material of the spacer body 108.

The spacer 102 may include a central opening 112 that is shaped and sized to receive a cytological sample 114 (e.g., a cell suspension). The spacer 102 may be formed in a variety of ways. For example, the material of the spacer 102 may be inkjet printed on the microscope slide base 104, the material may be applied to the microscope slide base 104 through a stencil, the material may be disposed on the microscope slide base 104 via a chemical vapor deposition process, and/or a preformed spacer 102 may be positioned on the microscope slide. For example, the preformed spacer 102 may be molded, cut (e.g., microtome cut) from a block, or preformed by another suitable method.

The spacer 102 may have a thickness that is associated with a thickness of cells in the cytological sample 114. For example, the thickness of the spacer 102 may be within about 20% of an average diameter of the cells of the cytological sample 114. In some examples, the thickness of the spacer 102 may be about 20 μm or less, such as between about 2 μm and about 8 μm (e.g., about 4 μm). A relatively thinner spacer 102 may be suitable for use with relatively smaller cells, while a relatively thicker spacer 102 may be suitable for use with relatively larger cells. Thus, when the optical focal feature 110 acts as an optical focal reference for a microscope, the microscope may be focused to a focal plane at the optical focal feature 110 that also corresponds to an appropriate focal plane for the cells in the cytological sample 114.

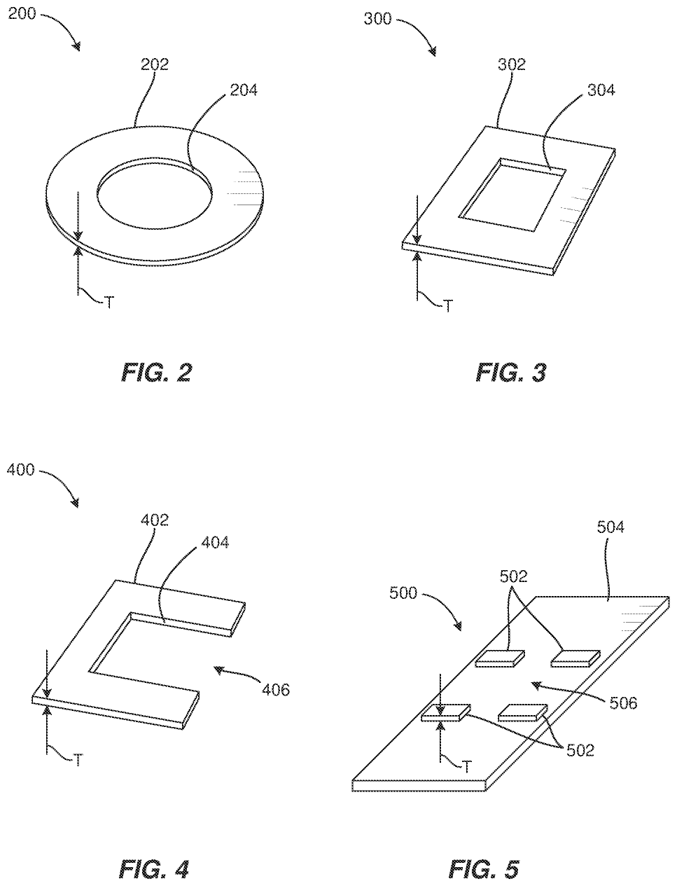

FIGS. 2-5 are perspective views of spacers 200, 300, 400, 500, respectively, having various configurations, according to several embodiments of the present disclosure.

As shown in FIG. 2, the spacer 200 may have a substantially circular outer perimeter 202 and a substantially circular central opening 204. As discussed above, the spacer 200 may have a thickness T that is within about 20% of an average diameter of cells in a corresponding cytological sample, such as about 20 μm or less.

In some examples, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least 90% met, at least 95% met, at least 99% met, or fully met.

As shown in FIG. 3, the spacer 300 may have a substantially rectangular outer perimeter 302 and a substantially rectangular central opening 304. As discussed above, the spacer 300 may have a thickness T that is within about 20% of an average diameter of cells in a corresponding cytological sample, such as about 20 μm or less.

As shown in FIG. 4, the spacer 400 may have a substantially rectangular outer perimeter 402 but may not define a fully enclosed central opening 404. Rather, the central opening 404 may include a gap 406 extending to the outer perimeter 402, such that the spacer 400 has a C-shape. In some embodiments, the spacer 400 may be used by introducing a cytological sample into the central opening 404 through the gap 406, such as via capillary action (e.g., between a corresponding microscope slide and cover slip). As discussed above, the spacer 400 may have a thickness T that is within about 20% of an average diameter of cells in a corresponding cytological sample, such as about 20 μm or less.

As shown in FIG. 5, the spacer 500 may be defined by a plurality (e.g., two or more) of distinct and separated spacer portions 502 configured to be positioned on a microscope slide base 504. A central opening 506 may be defined in a space between the spacer portions 502. As discussed above, the spacer 500 may have a thickness T that is within about 20% of an average diameter of cells in a corresponding cytological sample, such as about 20 μm or less.

The configurations of the spacers 200, 300, 400, 500 are illustrated in FIGS. 2-5 by way of example and not limitation. In additional embodiments, combinations of the configurations shown may be employed, such as a spacer having a circular outer perimeter and a rectangular central opening, a spacer having a rectangular outer perimeter and a circular central opening, a spacer having an outer perimeter and/or central opening of a shape different than circular or rectangular (e.g., triangular, irregular, oval, etc.), or other suitable shapes and configurations. In additional embodiments, the spacer may be in the form of a line (e.g., a printed line), which may be straight, curved, stepped, or intermittent, or a dot or series of dots (e.g., a printed dot or dots).

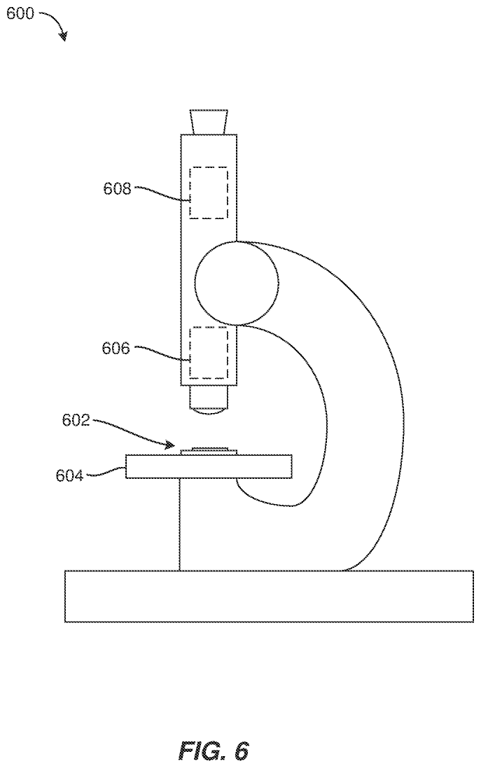

FIG. 6 is a side view of a microscope 600 in use with a microscope slide system 602 according to at least one embodiment of the present disclosure. The microscope slide system 602 may include a microscope slide and at least one spacer on the microscope slide, such as any of the spacers discussed above with reference to FIGS. 1-5. The microscope 600 may include a stage 604 on which to place the microscope slide system 602 for viewing. An optical module 606 may be configured to focus on at least one optical focal feature (e.g., a focal reference) of the spacer to define a focal plane for viewing cells in a cytological sample on the microscope slide system 602. For example, the optical module 606 may include one or more lenses, one or more actuators (e.g., for adjusting a distance between the lenses and/or between the lens(es) and the microscope slide system 602, for adjusting an angle of the lens(es), for adjusting a rotation of the lens(es), etc.), one or more optical filters, etc. In some embodiments, the microscope 600 may also include an image capture device 608, such as a digital image sensor, for capturing an image of the cytological sample on the microscope slide system 602.

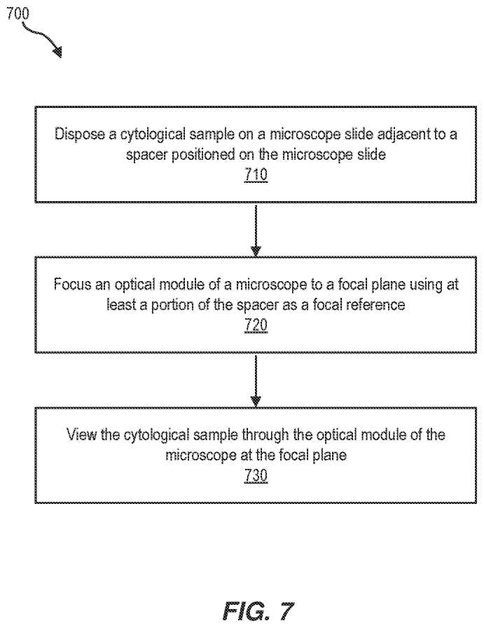

FIG. 7 is a flow diagram illustrating a method 700 of analyzing a cytological sample, according to at least one embodiment of the present disclosure. At operation 710, a cytological sample (e.g., cellular material suspended in a fluid) may be disposed on a microscope slide adjacent to a spacer positioned on the microscope slide. Operation 710 may be performed in a variety of ways. For example, any of the spacers described above with reference to FIGS. 1-5 may be positioned on a microscope slide on which the cytological solution is disposed. To dispose the cytological solution on the microscope slide, the cytological sample may be poured, transferred from a pipette, dropper, needle, or syringe, applied with a sponge or swab, etc.

At operation 720, an optical module of a microscope may be focused to a focal plane using at least a portion of the spacer as a focal reference. Operation 720 may be performed in a variety of ways. For example, the optical module 606 of the microscope 600 of FIG. 6 may be focused to the focal plane using one or more actuators (e.g., manual or electromechanical actuators) of the optical module 606. The spacer may be positioned within a field of view through the optical module 606, and the optical module 606 may be adjusted until an optical focal feature of the spacer is at least substantially in focus.

At operation 730, the cytological sample may be viewed through the optical module of the microscope at the focal plane. Operation 730 may be performed in a variety of ways. For example, one or both of the optical module and/or the microscope slide may be translated relative to each other to bring the cytological sample within the field of view through the optical module, without adjusting the focal plane at which the optical module is focused. In some examples, the cytological sample may be viewed with an image capture device (e.g., a digital image sensor). In some embodiments, an image of the cytological sample may be captured by the image capture device. Operation 730 may also be performed to identify, locate, and focus on one or more clusters of cells in the cytological sample. For example, once a cluster of cells has been located using a focal plane defined by the focal plane spacer, the focal plane of the microscope could be adjusted to discern details at varying levels (e.g., depths, higher and/or lower focal planes, etc.) through the identified cluster of cells. Thus, the focal plane spacer may assist in identifying an initial focal plane for locating clusters of cells or individual cells, and the optical module may then be adjusted to view a cluster of cells or an individual cell at different levels below or above the initial focal plane to identify additional information about the cluster of cells or the individual cell.

Accordingly, the spacers, methods, and systems of the present disclosure may facilitate viewing cells in a cytological sample through a microscope by providing at least one focal feature for a microscope at a focal plane in which cells of the cytological sample are positioned. This may facilitate locating and focusing on cells or clusters of cells in the cytological sample.

The following example embodiments are also disclosed:

Example 1: A spacer for a microscope slide, which may include: a spacer body including a material configured to provide an optical focal reference for a microscope, wherein the spacer body has a thickness of about 20 μm or less; and a central opening in the spacer body sized and shaped to receive a cytological sample.

Example 2: The spacer of Example 1, wherein the spacer body has a substantially circular outer perimeter.

Example 3: The spacer of Example 1, wherein the spacer body has a substantially rectangular outer perimeter.

Example 4: The spacer of any of Examples 1 through 3, wherein the central opening has a substantially circular shape.

Example 5: The spacer of any of Examples 1 through 3, wherein the central opening has a substantially rectangular shape.

Example 6: The spacer of any of Examples 1 through 5, wherein the material of the spacer body comprises a translucent material.

Example 7: The spacer of any of Examples 1 through 6, wherein the spacer body comprises at least one discrete focal feature.

Example 8: The spacer of Example 7, wherein the at least one discrete focal feature comprises at least one of: a pigment; a biological cell; a protein material; or a lipid material.

Example 9: A method of analyzing a cytological sample, which may include: disposing a cytological sample on a microscope slide adjacent to a spacer positioned on the microscope slide; focusing an optical module of a microscope to a focal plane using at least a portion of the spacer as a focal reference; and viewing the cytological sample through the optical module of the microscope at the focal plane.

Example 10: The method of Example 9, further comprising positioning the spacer on the microscope slide.

Example 11: The method of Example 10, wherein positioning the spacer on the microscope slide comprises positioning a spacer having a thickness of about 20 μm or less.

Example 12: The method of Example 10 or Example 11, wherein positioning the spacer on the microscope slide comprises at least one of: inkjet printing a material of the spacer on the microscope slide; applying the material of the spacer to the microscope slide through a stencil; disposing the material of the spacer on the microscope slide via a chemical vapor deposition process; or positioning a preformed spacer on the microscope slide.

Example 13: The method of any of Examples 9 through 12, further comprising capturing an image of the cytological sample with an image capture device through the optical module of the microscope.

Example 14: The method of Example 13, wherein the image capture device comprises a digital image sensor.

Example 15: The method of Example 13 or Example 14, wherein viewing the cytological sample through the optical module of the microscope at the focal plane comprises viewing the cytological sample with the image capture device.

Example 16: The method of any of Examples 9 through 15, wherein viewing the cytological sample through the optical module of the microscope at the focal plane comprises: identifying a cell or a cluster of cells at the focal plane; and viewing the identified cell or cluster of cells through the optical module at various depths.

Example 17: A microscope slide system, which may include: a microscope slide base; and a spacer positioned on the microscope slide base, wherein the spacer includes at least one optical focal reference feature for a microscope and the spacer has a thickness of about 20 μm or less.

Example 18: The system of Example 17, further comprising a cover slip configured to be positioned over the spacer.

Example 19: The system of Example 17 or Example 18, wherein the spacer comprises a central opening sized for receiving a cytological sample.

Example 20: The system of any of Examples 17 through 19, wherein the at least one optical focal reference feature comprises at least one of: a pigment; or a biological material.

Example 21: The system of any of Examples 17 through 20, wherein the spacer comprises distinct and separated spacer portions positioned on the microscope slide base.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of configurations. In addition, any disclosure of components contained within other components should be considered example in nature since many other architectures can be implemented to achieve the same functionality.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A spacer for a microscope slide, comprising:
a spacer body including a material configured to provide an optical focal reference for a microscope, wherein the spacer body has a thickness of about 20 μm or less, wherein the material of the spacer body comprises a translucent material; and
a central opening in the spacer body sized and shaped to receive a cytological sample.

2. The spacer of claim 1, wherein an outer perimeter of the spacer body has at least one of the following shapes: substantially circular; or substantially rectangular.

3. The spacer of claim 1, wherein the central opening has at least one of the following shapes: substantially circular; or substantially rectangular.

4. The spacer of claim 1, wherein the material of the spacer body further comprises at least one optical feature configured to act as an optical focal reference.

5. The spacer of claim 1, wherein the spacer body further comprises at least one discrete focal feature.

6. The spacer of claim 5, wherein the at least one discrete focal feature comprises at least one of:
a pigment;
a biological cell;
a protein material; or
a lipid material.

7. The spacer of claim 1, wherein the spacer body comprises a group of distinct and separated spacer portions that are configured to be positioned adjacent to each other on a microscope slide.

8. A method of analyzing a cytological sample, comprising:
disposing a cytological sample on a microscope slide adjacent to a spacer positioned on the microscope slide;
focusing an optical module of a microscope to a focal plane using at least a portion of the spacer as a focal reference; and
viewing the cytological sample through the optical module of the microscope at the focal plane.

9. The method of claim 8, further comprising positioning the spacer on the microscope slide.

10. The method of claim 9, wherein positioning the spacer on the microscope slide comprises positioning a spacer having a thickness of about 20 μm or less.

11. The method of claim 9, wherein positioning the spacer on the microscope slide comprises at least one of:
inkjet printing a material of the spacer on the microscope slide;
applying the material of the spacer to the microscope slide through a stencil;
disposing the material of the spacer on the microscope slide via a chemical vapor deposition process; or
positioning a preformed spacer on the microscope slide.

12. The method of claim 8, wherein viewing the cytological sample through the optical module of the microscope at the focal plane comprises:
identifying a cell or a cluster of cells at the focal plane; and
viewing the identified cell or cluster of cells through the optical module at various depths.

13. The method of claim 8, further comprising capturing an image of the cytological sample with an image capture device through the optical module of the microscope.

14. The method of claim 13, wherein the image capture device comprises a digital image sensor.

15. The method of claim 13, wherein viewing the cytological sample through the optical module of the microscope at the focal plane comprises viewing the cytological sample with the image capture device.

16. A microscope slide system, the system comprising:
a microscope slide base; and
a spacer positioned on the microscope slide base, wherein the spacer includes a transparent material and at least one optical focal reference feature for a microscope and the spacer has a thickness of about 20 μm or less.

17. The system of claim 16, further comprising a cover slip configured to be positioned over the spacer.

18. The system of claim 16, wherein the spacer comprises a central opening sized for receiving a cytological sample.

19. The system of claim 16, wherein the at least one optical focal reference feature comprises at least one of:
a pigment; or
a biological material.

20. The system of claim 16, wherein the spacer comprises distinct and separated spacer portions positioned on the microscope slide base.
